(19) United States
(12) Patent Application Publication
(10) Pub. No.: US 2022/0277625 A1
(43) Pub. Date: Sep. 1, 2022

(54) FORCE SENSE PRESENTATION APPARATUS, FORCE SENSE PRESENTATION METHOD

(71) Applicant: NIPPON TELEGRAPH AND TELEPHONE CORPORATION, Tokyo (JP)

(72) Inventors: Hiroshi CHIGIRA, Tokyo (JP); Hiroaki GOMI, Tokyo (JP)

(73) Assignee: NIPPON TELEGRAPH AND TELEPHONE CORPORATION, Tokyo (JP)

(21) Appl. No.: 17/624,559

(22) PCT Filed: Jul. 8, 2019
(86) PCT No.: PCT/JP2019/026987

§ 371 Date: Jan. 3, 2022

(51) Int. Cl. G08B 6/00

(52) U.S. Cl. CPC G08B 6/00

(57) ABSTRACT

There is provided a technique for presenting a force sense corresponding to a motion of a physical object without a power source. A force sense presentation apparatus includes a passive object, which is an object without a power source, a motion detection unit that generates data concerning a motion of the passive object (hereinafter referred to as first motion data), a force-sense presentation unit that determines, from the first motion data, data concerning a force sense corresponding to the motion of the passive object (hereinafter referred to as force sense data) and gives the force sense to a user based on the force sense data, and a wire for body motion for transmitting a body motion of the user to the passive object.

### TECHNICAL FIELD

The present invention relates to a technique for presenting a force sense and, more particularly, to a technique for presenting a force sense corresponding to a motion of an object without a power source.

### BACKGROUND ART

A technique for presenting a force sense (hereinafter referred to as force sense presentation technique) is used in various fields such as remote control for a robot and a video game. For example, a force sense presentation device described in Patent Literature 1 and Non-Patent Literature 1 is a device that simulatively presents a force sense using a transducer such as a vibrator. The force sense presentation device can present a force sense of being towed in a specific direction to a user who grips a small mobile terminal equipped with the device.

### CITATION LIST

### Patent Literature

Patent Literature 1: Japanese Patent Laid-Open No. 2017-63916

### Non-Patent Literature

Non-Patent Literature 1: Tomohiro Amemiya, Shinya Takamuku, Sho Ito, and Hiroaki Gomi, “Buru-Navi3 Gives You a Feeling of Being Pulled”, NTT Technical Review, Vol. 12, No. 11, November 2014.

### SUMMARY OF THE INVENTION

### Technical Problem

By combining the force sense presentation technique with a robot, it is possible to present a force sense corresponding to a motion of the robot. For example, by feeding back, to a user, as a force sense, a force applied to a housing of the robot when controlling the robot, it is possible to provide a simulated experience as if a force sense is given from the robot. In this case, a mechanism for linking a force sense presented by the force sense presentation device with the motion of the robot is necessary. In general, in order to cause the robot to generate a motion, it is necessary to provide, in the robot, components such as an actuator, a servomotor, an electric control unit such as an ESC (Electronic Speed Controller), and a power supply. In general, the robot including these components is expensive. Moreover, it is likely that a mechanism of the robot is complicated and the housing of the robot is increased in size. Accordingly, even if the force sense presentation device is reduced in size, it is difficult to realize a reduction in the size of an entire system including the robot and convenient operation in daily life.

Therefore, an object of the present invention is to provide a technique for presenting a force sense corresponding to a motion of a physical object without a power source (hereinafter referred to as passive object).

### Means for Solving the Problem

An aspect of the present invention includes: a passive object, which is an object without a power source; a motion detection unit that generates data concerning a motion of the passive object (hereinafter referred to as first motion data); a force-sense presentation unit that determines, from the first motion data, data concerning a force sense corresponding to the motion of the passive object (hereinafter referred to as force sense data) and gives the force sense to a user based on the force sense data; and a wire for body motion for transmitting a body motion of the user to the passive object.

An aspect of the present invention includes: a passive object, which is an object without a power source; a motion detection unit that generates data concerning a motion of a force-sense presentation unit (hereinafter referred to as second motion data); the force-sense presentation unit that determines, from the second motion data, data concerning a force sense corresponding to a motion of the passive object (hereinafter referred to as force sense data) and gives the force sense to a user based on the force sense data; and a wire for body motion for transmitting a body motion of the user to the passive object.

An aspect of the present invention includes: a passive object, which is an object without a power source; a positional-relation detection unit that generates data concerning a relative positional relation between the passive object and a force-sense presentation unit (hereinafter referred to as positional relation data); the force-sense presentation unit that determines, from the positional relation data, data concerning a force sense corresponding to a motion of the passive object (hereinafter referred to as force sense data) and gives the force sense to a user based on the force sense data; and a wire for body motion for transmitting a body motion of the user to the passive object.

### Effects of the Invention

According to the present invention, even when a physical object does not include a power source, it is possible to present a force sense corresponding to a motion of the physical object.

### BRIEF DESCRIPTION OF DRAWINGS

FIG. 1 is a block diagram showing an example of the configuration of a force sense presentation apparatus 100.

FIG. 2 is a flowchart showing an example of the operation of the force sense presentation apparatus 100.

FIG. 3 is a block diagram showing an example of the configuration of a motion detection unit 120.

FIG. 4 is a block diagram showing an example of the configuration of a force-sense presentation unit 130.

FIG. 5 is a diagram showing a state of the operation of the force sense presentation apparatus 100.

FIG. 6 is a block diagram showing an example of the configuration of a force sense presentation apparatus 200.

FIG. 7 is a flowchart showing an example of the operation of the force sense presentation apparatus 200.

FIG. 8 is a block diagram showing an example of the configuration of a motion detection unit 220.

FIG. 9 is a block diagram showing an example of the configuration of a force-sense presentation unit 230.

FIG. 10 is a diagram showing a state of the operation of the force sense presentation apparatus 200.

FIG. 11 is a block diagram showing an example of the configuration of a force sense presentation apparatus 300.

FIG. 12 is a flowchart showing an example of the operation of the force sense presentation apparatus 300.

FIG. 13 is a block diagram showing an example of the configuration of a positional-relation detection unit 320.

FIG. 14 is a block diagram showing an example of the configuration of a force-sense presentation unit 330.

FIG. 15 is a diagram showing an example of a functional configuration of a computer that realizes apparatuses in embodiments of the present invention.

### DESCRIPTION OF EMBODIMENTS

Embodiments of the present invention are explained below in detail. Note that constituent units having the same functions are denoted by the same numerals and redundant explanation of the constituent units is omitted.

### First Embodiment

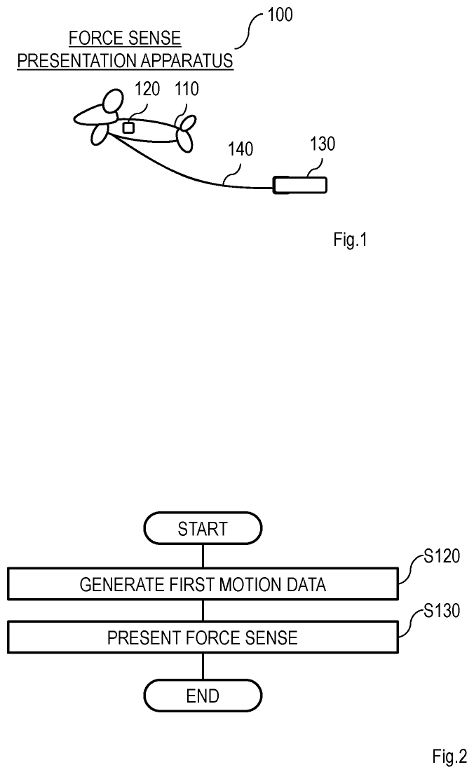

A force sense presentation apparatus 100 is explained below with reference to FIG. 1 and FIG. 2. FIG. 1 is a block diagram showing the configuration of the force sense presentation apparatus 100. FIG. 2 is a flowchart showing the operation of the force sense presentation apparatus 100. As shown in FIG. 1, the force sense presentation apparatus 100 includes a passive object 110, a motion detection unit 120, a force-sense presentation unit 130, and a wire for body motion 140. For example, when a dog-type object is used as the passive object 110, the force sense presentation apparatus 100 is a system that causes a user to virtually experience walking.

### [Passive Object 110]

The passive object 110 is an object that does not include a power source. Therefore, the passive object 110 moves by receiving an external force. A motion of the passive object 110 is passive. The passive object 110 is preferably relatively light in weight in consideration of a load on the user. The passive object 100 may have any shape. For example, the passive object 100 may be a balloon formed in a dog shape.

[Motion Detection Unit 120]

The motion detection unit 120 detects a motion of the passive object 110, generates data concerning the motion of the passive object 110 (hereinafter referred to as first motion data), and outputs the generated first motion data to the force-sense presentation unit 130. The motion detection unit 120 is mounted on or attached to the passive object 110.

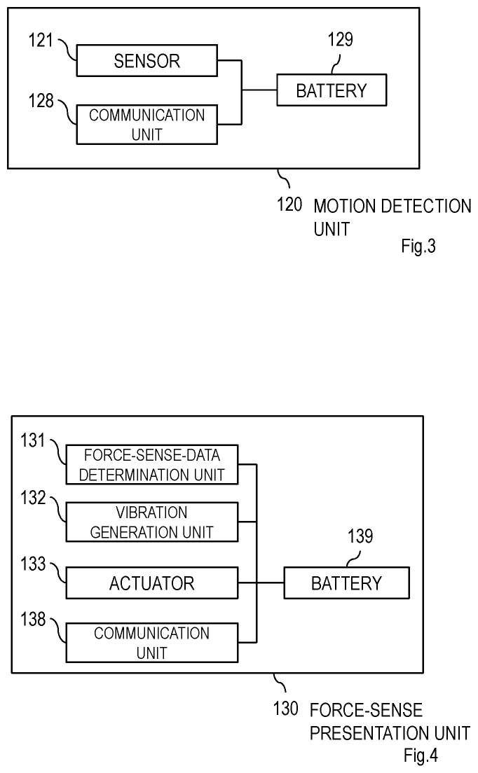

FIG. 3 is a block diagram showing the configuration of the motion detection unit 120. As shown in FIG. 3, the motion detection unit 120 includes a sensor 121, a communication unit 128, and a battery 129. The sensor 121 detects a motion of the passive object 110 and generates the first motion data. The sensor 121 may be an acceleration sensor, a gyro sensor, a terrestrial magnetism sensor, a GPS, or an inertial measurement unit (IMU) obtained by combining various sensors. The communication unit 128 transmits and receives data and, for example, transmits the first motion data indicating a detection result of the sensor 121 to the force-sense presentation unit 130. As a communication method, besides wireless communication such as Bluetooth (registered trademark), wired communication performed using a serial port to and from which signals can be input and output or a communication cable including interfaces for communication having shapes of general-purpose various connectors can be used. The general-purpose various connectors are, for example, a phone connector, an RCA connector, and an XLR type connector. Note that, in general, a form of the detection result of the sensor 121 is a signal specific to a sensor. However, a signal applied with an arithmetic processing such as electric conversion processing, smoothing, and delay in advance may be output to the communication unit 128 as the first motion data. Note that these kinds of processing may be executed by the force-sense presentation unit 130 instead of being executed by the motion detection unit 120. The battery 129 supplies electric power to the sensor 121 and the communication unit 128.

Note that, instead of mounting a battery on the motion detection unit 120, for example, electric power may be supplied from the force-sense presentation unit 130 using a power cable. By adopting such a configuration, it is possible to realize a reduction in the size and a reduction in the weight of the motion detection unit 120.

[Force-Sense Presentation Unit 130]

The force-sense presentation unit 130 determines, from the first motion data output by the motion detection unit 120, data concerning a force sense corresponding to a motion of the passive object 110 (hereinafter referred to as force sense data) and gives the force sense to the user based on the force sense data. The force-sense presentation unit 130 is a mobile device gripped by the user. The force sense is given to a hand (fingers or a palm) of the user. For example, the force-sense presentation unit 130 can be including a device that generates asymmetric vibration described in Patent Literature 1.

FIG. 4 is a block diagram showing the configuration of the force-sense presentation unit 130. As shown in FIG. 4, the force-sense presentation unit 130 includes a force-sense-data determination unit 131, a vibration generation unit 132, an actuator 133, a communication unit 138, and a battery 139. The force-sense-data determination unit 131 determines force sense data from the first motion data output by the motion detection unit 120. The vibration generation unit 132 generates vibration corresponding to the force sense data determined by the force-sense-data determination unit 131. The actuator 133 simulatively presents a force sense to the user using the vibration generated by the vibration generation unit 132. The communication unit 138 transmits and receives data and, for example, receives the first motion data transmitted by the communication unit 128 of the motion detection unit 120. The communication unit 138 uses a communication method corresponding to the communication unit 128. The battery 139 supplies electric power to the force-sense-data determination unit 131, the vibration generation unit 132, the actuator 133, and the communication unit 138.

[Wire for Body Motion 140]

The wire for body motion 140 connects the passive object 110 and the force-sense presentation unit 130 and transmits a body motion of the user gripping the force-sense presentation unit 130 to the passive object 110. Note that the wire for body motion 140 only has to be made of a material having rigidity enough to transmit the body motion of the user to the passive object 110. The wire for body motion 140 may be made of any material and may have any shape. Therefore, the wire for body motion 140 does not always need to be made of metal.

The operation of the force sense presentation apparatus 100 is explained below with reference to FIG. 2. When the user gripping the force-sense presentation unit 130 starts to move, a body motion associated with a motion of the body of the user occurs. The body motion is transmitted to the passive object 110 with the wire for body motion 140 as a medium. The motion detection unit 120 detects a motion of the passive object 110 and generates the first motion data (S120). The force-sense presentation unit 130 determines force sense data from the first motion data generated in S120 and gives a force sense to the user based on the force sense data (S130). When a body motion associated with a motion of the body of the user occurs anew, the body motion is transmitted to the passive object 110 with the wire for body motion 140 as a medium. The processing explained above is repeated.

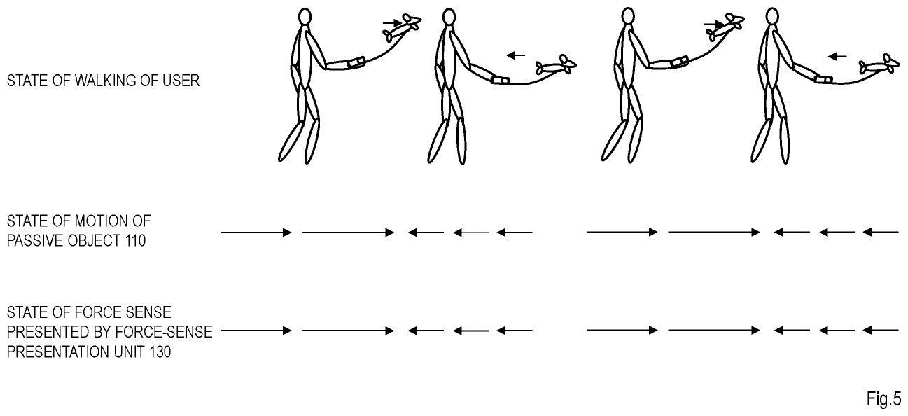

An operation example of the force sense presentation apparatus 100 that causes the user to virtually experience walking using the passive object 110 as a dog-type object is explained (see FIG. 5). When the user performs an initial walking action of gripping the force-sense presentation unit 130 and starting to walk, a body motion associated with the walking occurs in the body of the user. The body motion is transmitted to the passive object 110 as well through the wire for body motion 140. A motion occurs in the passive object 110. Subsequently, the motion detection unit 120 mounted on (or attached to) the passive object 110 detects the motion of the passive object 110 and generates data concerning the motion of the passive object 110 (the first motion data). The communication unit 128 of the motion detection unit 120 transmits the generated first motion data. The communication unit 138 of the force-sense presentation unit 130 receives the data. The force-sense presentation unit 130 determines force sense data corresponding to the data and simulatively presents a force sense to the user based on the force sense data.

As shown in FIG. 5, the motion of the passive object 110 and the force sense presented by the force-sense presentation unit 130 correspond to each other. For example, when an acceleration sensor is used as the sensor 121 of the motion detection unit 120 and the device described in Patent Literature 1 (that is, the device capable of causing the user to sense a force sense as a towing force in a specific direction) is used as the force-sense presentation unit 130, the acceleration sensor is mounted on (attached to) the passive object 110 such that a direction of any one of an X axis, a Y axis, or a Z axis of the acceleration sensor is an advancing direction of walking. Then, first motion data based on a measurement result in the axis is input to the force-sense presentation unit 130.

According to the embodiment of the present invention, even when a physical object does not include a power source, it is possible to present a force sense corresponding to a motion of the physical object. That is, even when a passive object does not include a power source, the passive object moves based on a body motion associated with a motion of a user and it is possible to present a force sense corresponding to the motion to the user. When the device described in Patent Literature 1 is used, it is possible to present a sense of being drawn by the passive object to the user. By using the passive object, it is possible to realistically virtually experience a force sense corresponding to a motion of the physical object inexpensively and simply.

### Second Embodiment

In a force sense presentation apparatus 200, a motion detection unit 220 is mounted on (attached to) a force-sense presentation unit 230 rather than the passive object 110.

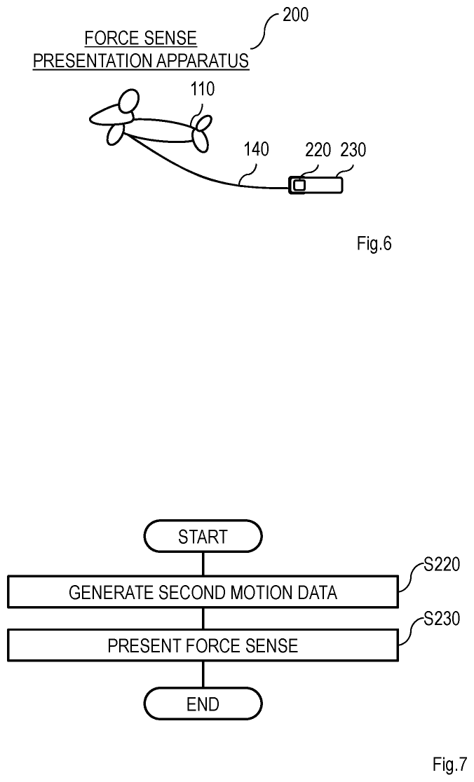

The force sense presentation apparatus 200 is explained below with reference to FIG. 6 and FIG. 7. FIG. 6 is a block diagram showing the configuration of the force sense presentation apparatus 200. FIG. 7 is a flowchart showing the operation of the force sense presentation apparatus 200. As shown in FIG. 6, the force sense presentation apparatus 200 includes the passive object 110, the motion detection unit 220, the force-sense presentation unit 230, and the wire for body motion 140.

### [Motion Detection Unit 220]

The motion detection unit 220 detects a motion of the force-sense presentation unit 230, generates data concerning the motion of the force-sense presentation unit 230 (hereinafter referred to as second motion data), and outputs the generated second motion data to the force-sense presentation unit 230. The motion detection unit 220 is mounted on or attached to the force-sense presentation unit 230.

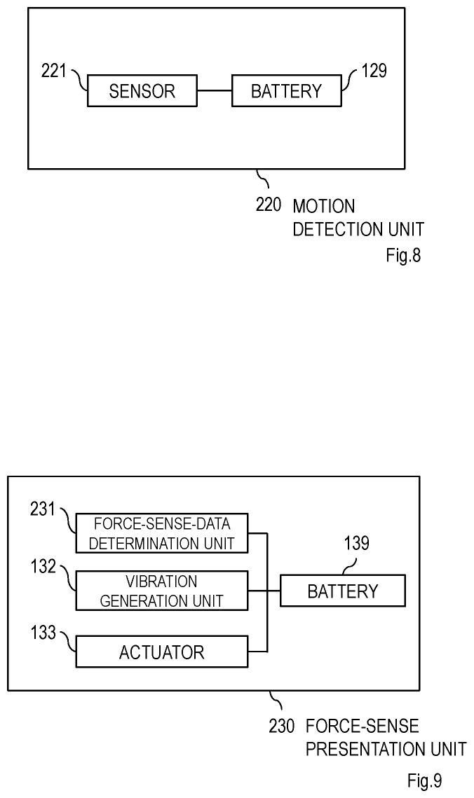

FIG. 8 is a block diagram showing the configuration of the motion detection unit 220. As shown in FIG. 8, the motion detection unit 220 includes a sensor 221 and the battery 129. The sensor 221 detects a motion of the force-sense presentation unit 230 and generates the second motion data. As the sensor 221, like the sensor 121, an acceleration sensor, a gyro sensor, a terrestrial magnetism sensor, a GPS, or an inertial measurement unit (IMU) obtained by combining various sensors can be used. The battery 129 supplies electric power to the sensor 221.

[Force-Sense Presentation Unit 230]

The force-sense presentation unit 230 determines, from the second motion data output by the motion detection unit 220, data concerning a force sense corresponding to a motion of the passive object 110 (hereinafter referred to as force sense data) and gives the force sense to the user based on the force sense data. The force-sense presentation unit 230 is a mobile device gripped by the user. The force sense is given to a hand (fingers or a palm) of the user. For example, the force-sense presentation unit 230 can be including the device that generates asymmetric vibration described in Patent Literature 1.

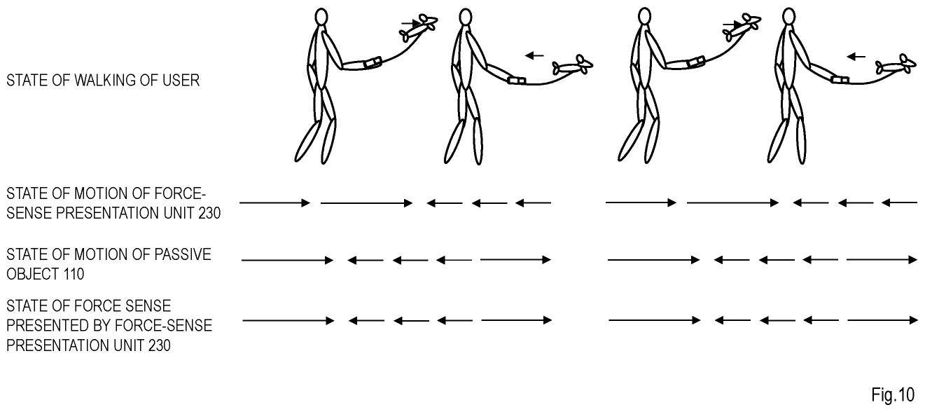

FIG. 9 is a block diagram showing the configuration of the force-sense presentation unit 230. As shown in FIG. 9, the force-sense presentation unit 230 includes a force-sense-data determination unit 231, the vibration generation unit 132, the actuator 133, and the battery 139. The force-sense-data determination unit 231 determines force sense data from the second motion data output by the motion detection unit 220. The force-sense-data determination unit 231 includes a recording unit (not shown) that records a correspondence relation between a motion of the force-sense presentation unit 230 and a motion of the passive object 110. The force-data determination unit 231 determines force sense data from the second motion data using the correspondence relation. An example of the correspondence relation is shown in FIG. 10. The correspondence relation is obtained by, for example, analyzing a photographed video of a state of a user, who uses the force sense presentation apparatus 200, and extracting the motion of the force-sense presentation unit 230 and the motion of the passive object 110. The force-sense-data determination unit 231 may record, in the recoding unit, a function obtained by modeling the correspondence relation between the motion of the force-sense presentation unit 230 and the motion of the passive object 110. The function receives the motion of the force-sense presentation unit 230 as an input and outputs the motion of the passive object 110. When the function is given as a function considering conversion by a predetermined filter and processing for giving a temporal delay, it is possible to change the magnitude and the direction of the force sense presented by the force-sense presentation unit 230 and a time period for presenting the force sense and it is possible to more realistically present a simulative force sense based on the motion of the passive object 110 to the user. The vibration generation unit 132 generates vibration corresponding to the force sense data determined by the force-sense-data determination unit 231. The actuator 133 simulatively presents the force sense to the user using the vibration generated by the vibration generation unit 132. The battery 139 supplies electric power to the force-sense-data determination unit 231, the vibration generation unit 132, and the actuator 133.

Note that, in the above explanation, the force-sense presentation unit 230 includes the force-sense-data determination unit 231. However, a function of the force-sense-data determination unit 231 may be provided by a server on Cloud. In this case, the motion detection unit 220 includes the sensor 221, the battery 129, and the communication unit 128 (not shown). The force-sense presentation unit 230 includes the vibration generation unit 132, the actuator 133, the battery 139, and the communication unit 138 (not shown). The operations of the motion detection unit 220 and the force-sense presentation unit 230 are explained below. The motion detection unit 220 transmits the generated second motion data to a server including the function of the force-sense-data determination unit 231. Subsequently, the server determines force sense data from the received second motion data and transmits the force sense data to the force-sense presentation unit 230. The force-sense presentation unit 230 gives a force sense to the user based on the received force sense data.

The operation of the force-sense presentation apparatus 200 is explained below with reference to FIG. 7. When the user gripping the force-sense presentation unit 230 starts to move, a body motion associated with a motion of the body of the user occurs. The motion detection unit 220 detects a motion of the force-sense presentation unit 230 and generates the second motion data (S220). The force-sense presentation unit 230 determines force sense data from the second motion data generated in S220 and gives a force sense to the user based on the force sense data (S230). The body motion associated with the motion of the body of the user is transmitted to the passive object 110 with the wire for body motion 140 as a medium. When a body motion associated with a motion of the body of the user occurs anew, the processing explained above is repeated.

According to the embodiment of the present invention, even when a physical object does not include a power source, it is possible to present a force sense corresponding to a motion of the physical object. The communication units necessary in the motion detection unit 120 and the force-sense presentation unit 130 are unnecessary in the motion detection unit 220 and the force-sense presentation unit 230. Therefore, the number of components of the motion detection unit 220 and the force-sense presentation unit 230 decreases. It is possible to achieve a reduction in cost. Since a motion detection unit is not mounted on the passive object 110, a total weight on the passive object 110 side decreases. It is possible to reduce physical fatigue and provide an experience with higher amusement when the user uses the force sense presentation apparatus 200.

### Third Embodiment

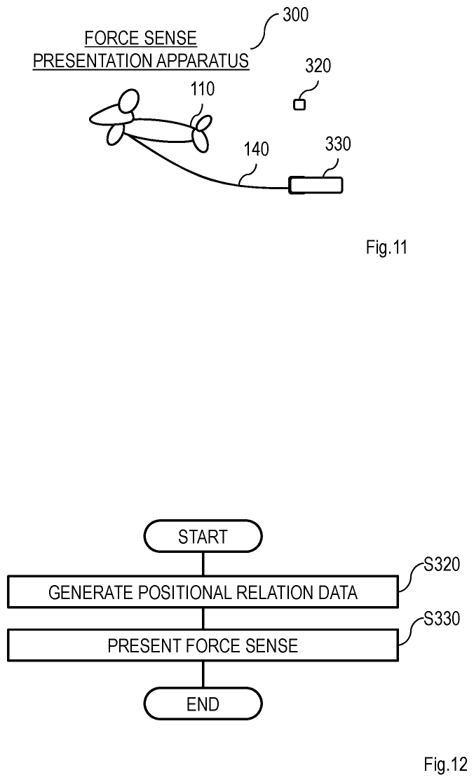

A force sense presentation apparatus 300 is explained below with reference to FIG. 11 and FIG. 12. FIG. 11 is a block diagram showing the configuration of the force sense presentation apparatus 300. FIG. 12 is a flowchart showing the operation of the force sense presentation apparatus 300. As shown in FIG. 11, the force sense presentation apparatus 300 includes the passive object 110, a positional-relation detection unit 320, a force-sense presentation unit 330, and the wire for body motion 140.

[Positional-Relation Detection Unit 320]

The positional-relation detection unit 320 detects a relative positional relation between the passive object 110 and the force-sense presentation unit 330, generates data concerning the relative positional relation between the passive object 110 and the force-sense presentation unit 330 (hereinafter referred to as positional relation data), and outputs the generated positional relation data to the force-sense presentation unit 330. Note that the positional-relation detection unit 320 is not mounted on (attached to) neither the passive object 110 nor the force-sense presentation unit 330.

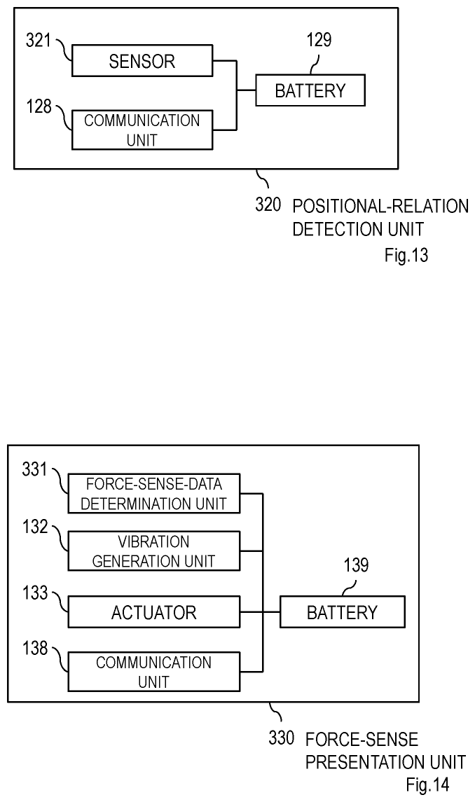

FIG. 13 is a block diagram showing the configuration of the positional-relation detection unit 320. As shown in FIG. 13, the positional-relation detection unit 320 includes a sensor 321, the communication unit 128, and the battery 129. The sensor 321 detects a relative positional relation between the passive object 110 and the force-sense presentation unit 330 and generates positional relation data. The sensor 321 is including, for example, a camera fixed to a wall or a ceiling. In this case, the sensor 321 analyzes a photographed video of a user to thereby detect the relative positional relation between the passive object 110 and the force-sense presentation unit 330 and generates the positional relation data. The sensor 321 is including, for example, a fixed laser distance sensor. In this case, the sensor 321 detects the relative positional relation between the passive object 110 and the force-sense presentation unit 330 using measured distance data and generates the positional relation data. The communication unit 128 transmits and receives data and, for example, transmits positional relation data indicating a detection result of the sensor 321 to the force-sense presentation unit 330. The battery 329 supplies electric power to the sensor 321 and the communication unit 128.

[Force-Sense Presentation Unit 330]

The force-sense presentation unit 330 determines, from the positional relation data output by the positional-relation detection unit 320, data concerning a force sense corresponding to a motion of the passive object 110 (hereinafter referred to as force sense data) and gives the force sense to the user based on the force sense data. The force-sense presentation unit 330 is a mobile device gripped by the user. The force sense is given to a hand (fingers or a palm) of the user. For example, the force-sense presentation unit 330 can be including the device that generates asymmetric vibration described in Patent Literature 1.

FIG. 14 is a block diagram showing the configuration of the force-sense presentation unit 330. As shown in FIG. 14, the force-sense presentation unit 330 includes a force-sense-data determination unit 331, the vibration generation unit 132, the actuator 133, the communication unit 138, and the battery 139. The force-sense-data determination unit 331 determines force sense data from the positional relation data output by the positional-relation detection unit 320. The vibration generation unit 132 generates vibration corresponding to the force sense data determined by the force-sense-data determination unit 331. The actuator 133 simulatively presents a force sense to the user using the vibration generated by the vibration generation unit 132. The communication unit 138 transmits and receives data and, for example, receives the positional relation data transmitted by the communication unit 128 of the positional-relation detection unit 320. The battery 139 supplies electric power to the force-sense-data determination unit 331, the vibration generation unit 132, the actuator 133, and the communication unit 138.

The operation of the force-sense presentation apparatus 300 is explained below with reference to FIG. 12. When the user gripping the force-sense presentation unit 330 starts to move, a body motion associated with a motion of the body of the user occurs and the body motion is transmitted to the passive object 110 with the wire for body motion 140 as a medium. The passive object 110 also moves. The positional-relation detection unit 320 detects a relative positional relation between the passive object 110 and the force-sense presentation unit 330 and generates positional relation data (S320). The force-sense presentation unit 330 determines force sense data from the positional relation data generated in S320 and gives a force sense to the user based on the force sense data (S330). When a body motion associated with a motion of the body of the user occurs anew, the body motion is transmitted to the passive object 110 with the wire for body motion 140 as a medium. The processing explained above is repeated.

According to the embodiment of the present invention, even when a physical object does not include a power source, it is possible to present a force sense corresponding to a motion of the physical object.

<Note>

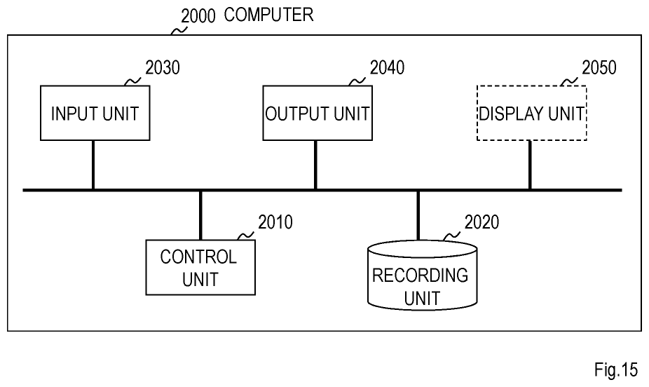

FIG. 15 is a diagram showing an example of a functional configuration of a computer that realizes the apparatuses explained above. The processing in the apparatuses explained above can be carried out by causing a recording unit 2020 to read a program for causing the computer to function as the apparatuses explained above and by causing the computer to operate as a control unit 2010, an input unit 2030, an output unit 2040, and the like.

An apparatus of the present invention includes, for example, as a single hardware entity, an input unit to which a keyboard and the like are connectable, an output unit to which a liquid crystal display and the like are connectable, a communication unit to which a communication device (for example, a communication cable) communicable to the outside of the hardware entity is connectable, a CPU (Central Processing Unit, which may include a cache memory and a register), a RAM and a ROM, which are memories, and an external storage device, which is a hard disk, and a bus for connecting the input unit, the output unit, the communication unit, the CPU, the RAM, the ROM, and the external storage device to enable exchange of data among the input unit, the output unit, the communication unit, the CPU, the RAM, the ROM, and the external storage device. A device (a drive) or the like that can perform reading and writing of a recording medium such as a CD-ROM may be provided in the hardware entity according to necessity. As a physical entity including such hardware resources, there is a general-purpose computer or the like.

In the external storage device of the hardware entity, programs necessary for realizing the functions explained above, data necessary in processing of the programs, and the like are stored (the programs may be stored in the ROM, which is a read only storage device, without being limitedly stored in the external storage device). Data and the like obtained by the processing of the programs are stored in the RAM, the external storage device, or the like as appropriate.

In the hardware entity, programs stored in the external storage device (or the ROM or the like) and data necessary for processing of the programs are read in a memory according to necessity and interpreted and executed and processed by the CPU as appropriate. As a result, the CPU realizes predetermined functions (the constituent elements described above as unit, means, and the like).

The present invention is not limited to the embodiments explained above and can be changed as appropriate in a range not departing from the gist of the present invention. The processing explained in the embodiments is not only executed in time series according to the described order and may be executed in parallel or individually according to processing abilities of the devices that execute the processing or according to necessity.

As explained above, when the processing functions in the hardware entity explained in the embodiments (the apparatuses of the present invention) are realized by the computer, processing content of functions that should be included in the hardware entity is described by a program. The program is executed by the computer, whereby the processing functions in the hardware entity are realized on the computer.

The program describing the processing content can be recorded in a computer-readable recording medium. The computer-readable recording medium may be any medium such as a magnetic recording device, an optical disk, a magneto-optical recording medium, or a semiconductor memory. Specifically, for example, as the magnetic recording device, a hard disk device, a flexible disk, a magnetic tape, and the like can be used, as the optical disk, a DVD (Digital Versatile Disc), a DVD-RAM (Random Access Memory), a CD-ROM (Compact Disc Read Only Memory), a CD-R (Recordable)/RW (ReWritable), and the like can be used, as the magneto-optical recording medium, an MO (Magneto-Optical disc) and the like can be used, and, as the semiconductor memory, an EEP-ROM (Electronically Erasable and Programmable-Read Only Memory) and the like can be used.

Distribution of the program is achieved by, for example, selling, transferring, or lending a portable recording medium such as a DVD or a CD-ROM having the program recorded thereon. Further, the program may be stored in a storage device of a server computer and distributed by being transferred from the server computer to other computers via a network.

For example, first, the computer executing such a program once stores, in a storage device of the computer, the program recorded in the portable recording medium or the program transferred from the server computer. During execution of the processing, the computer reads the program stored in the storage device of the computer and executes the processing conforming to the read program. As another execution form of the program, the computer may directly read the program from the portable recording medium and execute the processing conforming to the program. Further, every time the program is transferred to the computer from the server computer, the computer may sequentially execute the processing conforming to the received program. The processing explained above may be executed by a so-called ASP (Application Service Provider)-type service for realizing the processing function only with an execution instruction for the program and result acquisition without performing transfer of the program to the computer from the server computer. Note that the program in this form includes information served for processing by an electronic computer and equivalent to the program (for example, data that is not a direct instruction to the computer but has a characteristic for specifying the processing of the computer).

In this form, the hardware entity is configured by causing the computer to execute a predetermined program. However, at least a part of the processing content may be realized in a hardware manner.

The foregoing descriptions of the embodiments of the present invention have been presented for purposes of illustration and description. There is no intention to be exhaustive and there is no intention to limit the invention to the exact form disclosed. Modifications and variation are possible from the above teachings. The embodiments are chosen and expressed in order to provide the best illustration of the principles of the present invention, and to enable those skilled in the art to adapt the present invention in various embodiments and in a variety of ways suitable for practical use and to be able to be used with the addition of deformation. All such modifications and variations are within the scope of the present invention as defined by the appended claims, which are construed in accordance with the breadth that is imparted fairly and legally.

1. A force sense presentation apparatus comprising:
a passive object, which is an object without a power source;
a motion detection circuit configured to generate data concerning a motion of the passive object (hereinafter referred to as first motion data);
a force-sense presentation circuit configured to determine, from the first motion data, data concerning a force sense corresponding to the motion of the passive object (hereinafter referred to as force sense data) and gives the force sense to a user based on the force sense data; and
a wire for body motion for transmitting a body motion of the user to the passive object.

2. A force sense presentation apparatus comprising:
a passive object, which is an object without a power source;
a motion detection circuit configured to generate data concerning a motion of a force-sense presentation circuit (hereinafter referred to as second motion data);
the force-sense presentation circuit configured to determine, from the second motion data, data concerning a force sense corresponding to a motion of the passive object (hereinafter referred to as force sense data) and gives the force sense to a user based on the force sense data; and
a wire for body motion for transmitting a body motion of the user to the passive object.

3. A force sense presentation apparatus comprising:
a passive object, which is an object without a power source;
a positional-relation detection circuit configured to generate data concerning a relative positional relation between the passive object and a force-sense presentation circuit (hereinafter referred to as positional relation data);
the force-sense presentation circuit configured to determine, from the positional relation data, data concerning a force sense corresponding to a motion of the passive object (hereinafter referred to as force sense data) and gives the force sense to a user based on the force sense data; and
a wire for body motion for transmitting a body motion of the user to the passive object.

4. A force sense presentation method for executing, in a force sense presentation apparatus including a passive object, which is an object without a power source, a motion detection circuit, a force-sense presentation circuit, and a wire for body motion that transmits a body motion of a user to the passive object:
a motion detection step in which the motion detection circuit generates data concerning a motion of the passive object (hereinafter referred to as first motion data); and
a force-sense presentation step in which the force-sense presentation circuit determines, from the first motion data, data concerning a force sense corresponding to the motion of the passive object (hereinafter referred to as force sense data) and gives the force sense to the user based on the force sense data.

5. A force sense presentation method for executing, in a force sense presentation apparatus including a passive object, which is an object without a power source, a motion detection circuit, a force-sense presentation circuit, and a wire for body motion that transmits a body motion of a user to the passive object:
a motion detection step in which the motion detection circuit generates data concerning a motion of the force-sense presentation circuit (hereinafter referred to as second motion data); and
a force-sense presentation step in which the force-sense presentation circuit determines, from the second motion data, data concerning a force sense corresponding to a motion of the passive object (hereinafter referred to as force sense data) and gives the force sense to the user based on the force sense data.

6. A force sense presentation method for executing, in a force sense presentation apparatus including a passive object, which is an object without a power source, a positional-relation detection circuit, a force-sense presentation circuit, and a wire for body motion that transmits a body motion of a user to the passive object:
a positional-relation detection step in which the positional-relation detection circuit generates data concerning a relative positional relation between the passive object and the force-sense presentation circuit (hereinafter referred to as positional relation data); and
a force-sense presentation step in which the force-sense presentation circuit determines, from the positional relation data, data concerning a force sense corresponding to a motion of the passive object (hereinafter referred to as force sense data) and gives the force sense to the user based on the force sense data.
